(19) United States
(12) Patent Application Publication
(10) Pub. No.: US 2018/0091503 A1
(43) Pub. Date: Mar. 29, 2018

(54) NETWORKED STORAGE SYSTEM AND METHOD

(71) Applicant: Shanghai Yishan Industrial Co., Ltd., Shanghai (CN)

(72) Inventor: Ben Wu Tang, Shanghai (CN)

(21) Appl. No.: 15/277,338

(22) Filed: Sep. 27, 2016

(51) Int. Cl. H04L 29/06; G07C 9/00

(52) U.S. Cl. CPC H04L 63/0861; G07C 9/00912; G07C 9/00166; H04L 63/083

(57) ABSTRACT

A networked storage system and method provides multiple lockers arranged in a modular configuration, and multiple security means for accessing and monitoring lockers through an interconnected network of processors, user identifiers, and detectors that alert to unauthorized access to the lockers. The lockers are networked with a central kiosk and a remote processor for a user to access the lockers, for storing locker information, for monitoring lockers, and for processing events at lockers. The remote processor stores locker information, identifying characteristics of the user, a barcode, and a rewritable locker access code. Each locker has a door lock that retains a door in a locked position, and is releasable to an unlocked position upon: authentication of the identifying characteristic of user, scanning of barcode, and entry of rewritable locker access code. Each locker has a motion detection apparatus for detecting and alerting to unauthorized manipulation of items in the lockers.

### FIELD OF THE INVENTION

The present invention relates generally to a networked storage system and method. More so, the present invention relates to a networked system and method that provides a plurality of lockers for storing items; whereby the lockers have a modular configuration for facilitated mobility and adaptation into multiple configurations; whereby the lockers are networked with a central kiosk and a remote processor for enabling a user to access the lockers, for storing locker information, for monitoring the lockers, and for processing events at the lockers; whereby a network allows communication between the user, the central kiosk, and the remote processor to enable access and monitoring of the lockers; whereby the remote processor is configured to store at least one identifying characteristic, a barcode, and a rewritable locker access code from the user; whereby each locker has a door lock that releasably retains a door of the locker in a locked position, and is releasable to an unlocked position upon actuation of at least one of the following events: authentication of the identifying characteristic of the user, scanning of the barcode, and entry of the rewritable locker access code; whereby each locker has an enclosure defined by an interior for storing items; whereby each locker has a motion detection apparatus in the interior for monitoring the items and indicating unauthorized manipulation of the items to the central kiosk and the remote processor; and whereby a vending apparatus dispenses a product that may be pertinent to the location of the lockers.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, lockers are small, usually narrow storage compartments. They are commonly found in dedicated cabinets, very often in large numbers, in various public places such as locker rooms, workplaces, middle and high schools, transport hub, and the like. Lockers vary in size, purpose, construction, and security. Multiple individual lockers may be joined together through various fastening means known in the art. Lockers are often equipped with a lock, or at least a facility for padlocking.

Often, lockers are intended for use in public places, and intended for the short- or long-term private use of individuals for storing clothing or other personal items. Typically, a user may rent a locker for a single use or for a period of time for repeated use. Some lockers are offered as a free service to people partaking of certain activities that require the safekeeping of personal items.

It is known that most lockers require a security mechanism to safely store the items contained therein. Some lockers use purely mechanical locks that comprise cumbersome mechanical components and the use of a key, a combination dial, or similar means. Such mechanical locks require time to manipulate a key or enter a combination. This is undesirable in situations where it may be necessary to quickly access the items in the locker. The mechanical components are subject to wear and failure. Keys and combinations can be obtained by unauthorized individuals. These drawbacks and others make the use of mechanical locks undesirable.

In many instances, lockers or lock boxes utilize biometrics, such as fingerprint or thumbprint scanning technology for authorizing the opening of an electronic lock for the locker. Fingerprint or thumbprint scanning technology activate or enable an operational mode necessary for unlocking the locker.

Other lockers may utilize electronic code-entry systems for electromechanical locking means. For example, some lockers require that a code be keyed in on a keypad. These lockers are subject to the same drawbacks as mechanical systems where codes can be accessed and used by unauthorized personnel or entry and access is undesirably delayed due to the time to key in the code. Access may be altogether prevented where a user cannot remember the access code.

Other proposals have involved lockers and the security access means of lockers. The problem with these lockers is that they provide only a single means of security, and access is not networked to authenticate the authorized user of the locker. Even though the above cited lockers and locking mechanisms for lockers meet some of the needs of the market, a networked storage system and method that provides multiple lockers arranged in a modular configuration, and multiple security means for accessing and monitoring the lockers through an interconnected network is still desired.

### SUMMARY

Illustrative embodiments of the disclosure are generally directed to a networked storage system and method. The networked storage system and method provides multiple lockers arranged in a modular configuration, and multiple security means for accessing and monitoring a plurality of lockers through an interconnected network of processors, user identifiers, and detectors that alert to unauthorized access to the lockers. In one embodiment, the networked storage system and method provides a plurality of lockers for storing items. The lockers have a modular configuration that enables adaptation into multiple configurations, and facilitated mobility of the networked storage system. In this manner, the lockers may be adapted for different locations and manipulated to accommodate changing storage requirements.

The lockers are controlled by a central kiosk having an input device and an identifying characteristic reader. The central kiosk is generally proximal to the lockers, such that a user may easily access the central kiosk to allow access to the lockers, or perform other general functions pertinent to the lockers. The central kiosk may have a memory for storing locker information, and also pertinent information about the user. The input device and the identifying characteristic reader of the central kiosk may be engaged by a user to: access the lockers, input locker information, input special instructions pertaining to the lockers and the user, and inquire about locker information.

The central kiosk may include an input device that allows the user to access the lockers, and inquire about locker information. In one embodiment, the input device is a touch screen. The touch screen is configured to enable facilitated control and access of the locker. The touch screen may be layered on the top of an electronic visual display of the central kiosk. The user can give input or control the central kiosk through simple or multi-touch gestures by touching the touch screen with a special stylus and/or one or more fingers.

The central kiosk is networked to a remote processor. The remote processor stores the locker information, at least one identifying characteristics of the user, a barcode, and a rewritable locker access code. The remote processor is also configured to store locker information, monitor the lockers, process events at the lockers, and alert to unauthorized events at the lockers.

The locker information may include, without limitation, a location of the plurality of lockers, an identification of the plurality of lockers, a locker number, a locker rental cost, a user associate with the plurality of lockers, locker access information, the at least one identifying characteristic, the barcode, the rewritable locker access code, an activation indication indicating whether one of the plurality of lockers has been accessed, a use indication indicating whether the plurality of lockers is being rented for single re-entry or multiple re-entry type use, and a duration indicating a time period over which the plurality of lockers are accessible in accordance with a locker rental plan. The central kiosk may use this locker information for enabling a user to access the lockers, for monitoring the lockers, and for processing events at the lockers.

In some embodiments, the central kiosk may be networked with a remote processor. The remote processor may be remotely located from the lockers. The remote processor is configured to store the locker information and also information about the user. The remote processor may also monitor events that occur at the lockers. In one embodiment, the remote processor operatively connects to multiple servers that serve multiple sets of lockers.

In one embodiment, locker information that is input by the user into the central kiosk is stored in the remote processor. In some embodiments, a network allows communication between the user, the central kiosk, and the remote processor. The open communication allowed by the network enables access to the lockers and facilitates monitoring of the lockers.

In some embodiments, each locker has a door lock that releasably retains a door of the locker in a locked position. The locked position restricts unauthorized access to the interior of the locker. The door is releasable to an unlocked position upon actuation of at least one of the following events: detection of at least one identifying characteristic of the user, scanning of a barcode, and entry of a rewritable locker access code.

The remote processor is configured to store the at least one identifying characteristic from the user. An identifying characteristic reader operatively connects to the central kiosk and the door lock of the lockers. The identifying characteristic reader selectively unlocks the door when the identifying characteristic is authenticated by the user. In this manner, the user may authenticate the identifying characteristic at the central kiosk to release the door lock and consequently, access the locker.

The at least one identifying characteristic may include a biometric, such as: fingerprint, palm veins, finger veins, face recognition, voice recognition, DNA, palm print, hand geometry, iris recognition, retina, and scent. In one embodiment, the identifying characteristic of voice recognition enables voice activation of the central kiosk to access and regulate the lockers. In this manner, the user may speak directly to the central kiosk to unlock the door of a locker or provide instructions for the lockers.

The remote processor is configured to store data from a barcode. The barcode may include, without limitation, an IC card, an e-card, a magnetic barcode card, and a barcode bracelet. A barcode scanner operatively connects to the central kiosk and the door lock of the plurality of lockers. The barcode scanner selectively unlocks the door when scanning the barcode. The barcode scanner scans the barcode to release the door to the unlocked position.

The remote processor is configured to store a rewritable locker access code. The rewritable locker access code may be a password generated by the user. An access code reader operatively connects to the central kiosk and the door lock of the plurality of lockers. The access code reader selectively unlocks the door when reading the rewritable locker access code. The user may enter the rewritable locker access code into the central kiosk to release the door to the unlocked position. The user may also rewrite the rewritable locker access code, or enter special instructions for the locker through the input device of the central kiosk.

Furthermore, each locker includes an enclosure defining an interior for storing items. As an added security feature, a motion detection apparatus in the interior monitors the items and alerts to unauthorized manipulation of the items to the remote processor. The motion detection apparatus detects motion in the interior of the lockers, and indicates to the remote processor when motion is detected in the interior of the lockers. The motion detection apparatus may include a laser, an infrared, an optical, a microwave, an acoustic sensor, and a transmitter for illumination.

In an alternative embodiment, the central kiosk includes a vending apparatus that dispenses a vended product, such as a towel, a drink, a garment, and glasses, that may be pertinent to the location of the lockers. The user may pay for the vended product at the central kiosk through cash, credit card, and virtual currency. The locker information may also include a currency balance of the user. The user may actuate the identifying characteristic, the barcode, or the rewriteable locker access code to pay for the vended product from the currency balance. In another alternative embodiment, the central kiosk comprises a charging dock for charging an electronic device.

In one aspect, a networked storage system, comprises:
a plurality of lockers defined by a modular arrangement configured to enable multiple arrangement, the plurality of lockers comprising an enclosure defining an interior, the plurality of lockers further comprising a door configured to enable and restrict access to the interior, the door having a door lock configured to move between a locked position and an unlocked position,
whereby the door inhibits access to the interior when the door lock is in the locked position and the door allows access to the interior when the door lock is in the open position;
a central kiosk configured to operatively connect to the plurality of lockers, the central kiosk further configured to control the door lock of the plurality of lockers through an input device, the central kiosk further configured to store a locker information;
a remote processor configured to operatively connect to the plurality of lockers and the central kiosk, the remote processor having a memory configured to store the locker information;
a network configured to enable communication between the central kiosk, the remote processor, and the plurality of lockers;
an identifying characteristic reader configured to operatively connect to the central kiosk and the door lock of the plurality of lockers, the identifying characteristic reader further configured to selectively unlock the door when authenticating at least one identifying characteristic;
a barcode scanner configured to operatively connect to the central kiosk and the door lock of the plurality of lockers, the barcode scanner further configured to selectively unlock the door when scanning a barcode;
an access code reader configured to operatively connect to the central kiosk and the door lock of the plurality of lockers, the access code reader further configured to selectively unlock the door when reading a rewritable locker access code; and
motion detection apparatus disposed in the interior of the plurality of lockers, the motion detection apparatus configured to detect motion in the interior of the plurality of lockers, the motion detection apparatus further configured to indicate to the remote processor when motion is detected in the interior of the plurality of lockers,
whereby the remote processor emits an alert upon receiving indication of motion in the interior of the plurality of lockers.

In another aspect, the plurality of lockers are configured in a stacked arrangement.

In another aspect, the input device is a touch screen.

In another aspect, the remote processor includes at least one member selected from the group consisting of: a computer, a database, a server, a cloud, and a data storage device.

In another aspect, the locker information includes at least one member selected from the group consisting of: a location of the plurality of lockers, an identification of the plurality of lockers, a user associate with the plurality of lockers, the at least one identifying characteristic, the barcode, the rewritable locker access code, an activation indication indicating whether one of the plurality of lockers has been accessed, a use indication indicating whether the plurality of lockers is being rented for single re-entry or multiple re-entry type use, and a duration indicating a time period over which the plurality of lockers are accessible in accordance with a locker rental plan.

In another aspect, the remote processor is configured for backstage management of the locker information.

In another aspect, the network comprises an application.

In another aspect, the application includes at least one member selected from the group consisting of: a website, a social media site, a video, a digital audio, a fax, an email, and a call center.

In another aspect, the at least one identifying characteristic comprises a biometric.

In another aspect, the biometric includes at least one member selected from the group consisting of: fingerprint, palm veins, finger veins, face recognition, voice recognition, DNA, palm print, hand geometry, iris recognition, retina, and scent.

In another aspect, the voice recognition is configured to enable voice activation of the central kiosk.

In another aspect, the barcode includes at least one member selected from the group consisting of: an IC card, an e-card, a magnetic barcode card, and a barcode bracelet.

In another aspect, the rewritable locker access code comprises a password.

In another aspect, the motion detection apparatus includes at least one member selected from the group consisting of: a laser, an infrared, an optical, a microwave, an acoustic sensor, and a transmitter for illumination.

In another aspect, the central kiosk is configured to operatively connect to a vending apparatus.

In another aspect, the vending apparatus is configured to dispense at least one of the following: a towel, a drink, a garment, and glasses.

In another aspect, the central kiosk is configured to operatively connect to a charging dock.

In another aspect, the charging dock is configured to charge an electronic device.

One objective of the present invention is to provide safe storage of items in a plurality of lockers.

Another objective is to arrange the lockers in multiple configurations and enable mobility of the lockers.

Another objective is to provide secure access of the lockers with a barcode, at least one identifying characteristic of a user, and a rewritable locker access code.

Yet another objective is to provide a reliable network between the central kiosk and the remote processor for communicating information pertinent to the lockers and the user.

Yet another objective is to detect unauthorized motion or removal of items from the lockers.

Yet another objective is to enable backstage management of the information pertinent to the lockers.

Yet another objective is to store the information pertinent to the lockers in the remote processor.

Yet another objective is to enable touch screen activation of the central kiosk through the input device for accessing the lockers.

Yet another objective is to enable voice activation of the central kiosk through the at least one identifying characteristic reader for accessing the lockers.

Yet another objective is to enable charging of an electronic device at the central kiosk.

Yet another objective is to enable cost effective rental of the lockers.

Yet another objective is to provide a choice of free access to the lockers or paid access to the lockers.

Yet another objective is to provide an easy to operate and access storage system of modular lockers.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a block diagram of an exemplary networked storage system, in accordance with an embodiment of the present invention;

FIG. 2 illustrates a perspective view of a plurality of lockers and a central kiosk, in accordance with an embodiment of the present invention;

FIGS. 3A-3F illustrate frontal views of various arrangements of lockers and a central kiosk, in accordance with an embodiment of the present invention;

FIGS. 4A and 4B illustrate frontal views of modular lockers expanding the number of lockers from two columns of lockers to four columns of lockers, in accordance with an embodiment of the present invention;

FIG. 5 illustrates a close up view of a central kiosk having a touch screen and an identifying characteristic reader, in accordance with an embodiment of the present invention;

FIG. 6 illustrates a block diagram of a remote processor operatively connected with the central kiosk and multiple servers for operating multiple sets of lockers, in accordance with an embodiment of the present invention;

FIG. 7 illustrates a frontal view of a memory of the remote processor for storing locker information, in accordance with an embodiment of the present invention;

FIG. 8 illustrates a frontal view of the central kiosk having a multifunctional interface for performing backstage management of the locker information and the user information by the remote processor, in accordance with an embodiment of the present invention;

FIGS. 9A and 9B illustrate perspective views of identifying characteristics of a user, where FIG. 9A is a finger vein, and FIG. 9B is a facial recognition, in accordance with an embodiment of the present invention;

FIGS. 10A and 10B illustrate perspective views of a barcode, where FIG. 10A is a barcode, and FIG. 10B is a barcode scanner scanning an IC card on a bracelet, in accordance with an embodiment of the present invention;

FIG. 11 illustrates a frontal view of a rewritable locker access code, in accordance with an embodiment of the present invention;

FIG. 12 illustrates a perspective view of a motion detection apparatus, in accordance with an embodiment of the present invention; and

FIG. 13 illustrates a flowchart of an exemplary networked storage method, in accordance with an embodiment of the present invention.

Like reference numerals refer to like parts throughout the various views of the drawings.

### DETAILED DESCRIPTION OF THE INVENTION

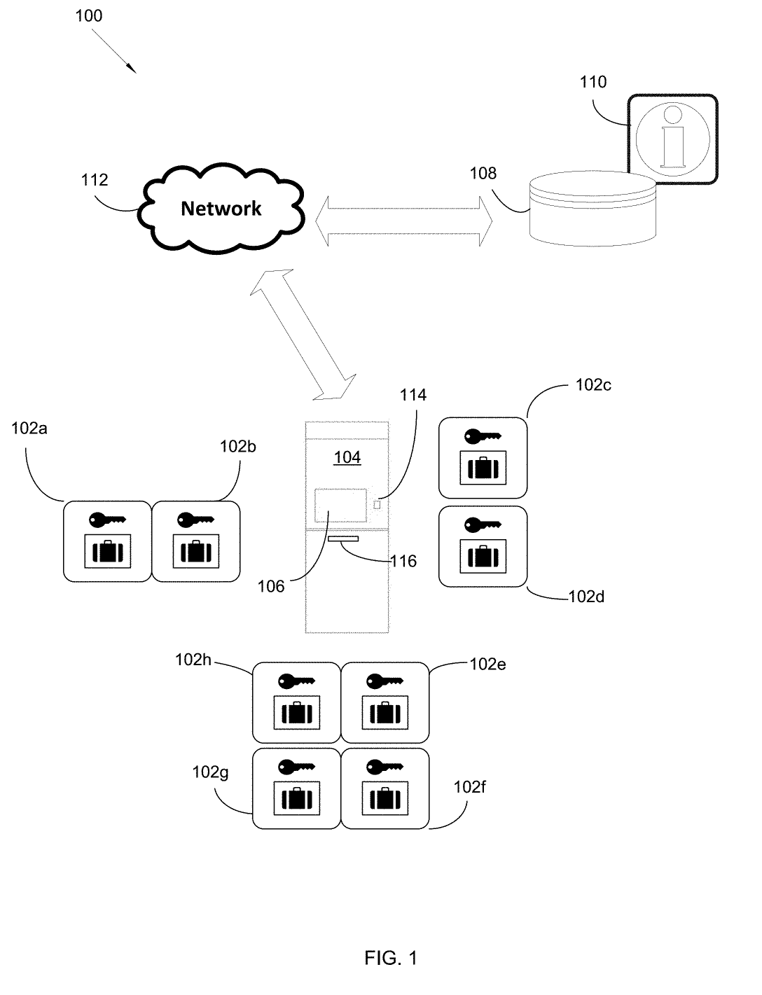

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

A networked storage system 100 and method 200 is referenced in FIGS. 1-13. The networked storage system and method provides multiple lockers arranged in a modular configuration, and multiple security means for accessing and monitoring a plurality of lockers 102a-1 through an interconnected network of processors, user identifiers, and detectors that alert to unauthorized access to the lockers 102a-1. Further, the networked storage system 100 and method 200 enables facilitated interactivity between a central kiosk 104 that controls the lockers 102a-1 and a user through an input device 106, such as a touch screen, and an identifying characteristic reader 114.

As referenced in FIG. 1, a networked storage system 100 provides multiple lockers 102a-1 for storing items. The lockers 102a-1 have a modular configuration for adaptation into multiple configurations. The lockers 102a-1 are controlled by a central kiosk 104 having an input device 106 and an identifying characteristic reader 114. The input device 106 and the identifying characteristic reader 114 of the central kiosk 104 may be engaged by a user to: access the lockers 102a-1, input locker information 110, input special instructions pertaining to the lockers 102a-1 and the user, and inquire about locker information 110. The central kiosk 104 is networked to a remote processor 108. The remote processor 108 stores at least one identifying characteristics of the user, a barcode, and a rewritable locker access code. The remote processor 108 is also configured to store locker information 110, monitor the lockers 102a-1, process events at the lockers 102a-1, and alert to unauthorized events at the lockers 102a-1.

Further, each locker 102a-1 has a door lock that releasably retains a door of the locker 102a-1 in a locked position, and is releasable to an unlocked position upon at least one of the following: authentication of the identifying characteristic 900a, 900b of the user, scanning of the barcode 1000, and entry of the rewritable locker access code 1100. Further, each locker 102a-1 has a motion detection apparatus 1200 for monitoring stored items and alerting to unauthorized manipulation of items to the remote processor 108 and/or the central kiosk 104. A vending apparatus (not shown) may also be integrated into the central kiosk 104 to vend a vended object.

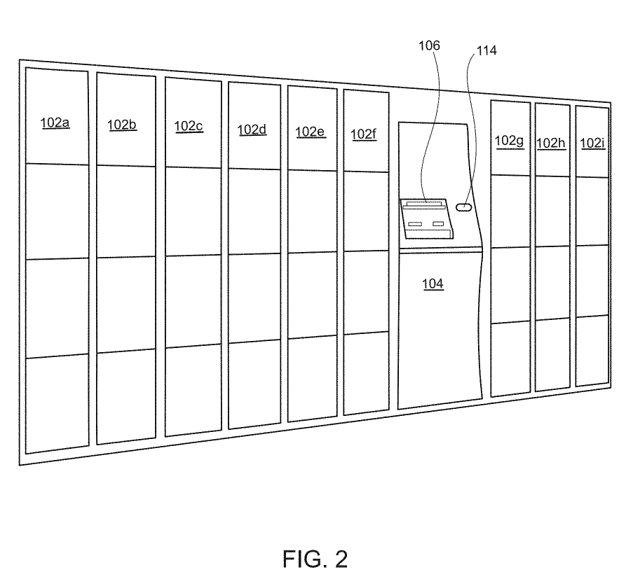

As referenced in FIG. 2, a networked storage system 100 provides a plurality of lockers 102a-1 for storing items. Each locker includes an enclosure defining an interior for storing items. Each locker has a door and a door lock. The door lock moves between an unlocked position that enables access to an interior of the locker, and a locked position that releasably locks the door. The locked position restricts unauthorized access to the interior of the locker. The lockers 102a-1 may be joined together through various fastening means known in the art. In some embodiments, the lockers 102a-1 may be equipped with a lock, or at least a facility for padlocking.

In some embodiments, the lockers 102a-1 may also be intended for use in public places, and intended for the short- or long-term private use of individuals for storing clothing or other personal items. Typically, a user may rent a locker 102a for a single use or for a period of time for repeated use. Some lockers 102a-1 are offered as a free service to people partaking of certain activities that require the safekeeping of personal items.

The lockers 102a-1 may be adapted to accommodate items that relate to the location of the lockers 102a-1. For example, in a school environment, the lockers 102a-1 may be 5′×2′ to store books and garments. In a food storage environment, the lockers 102a-1 may be refrigerated to store food and drinks. Suitable materials for the lockers 102a-1 may include, without limitation, aluminum, steel, a rigid polymer, polyurethane, wood, and fiberglass. A central kiosk 104, described below.

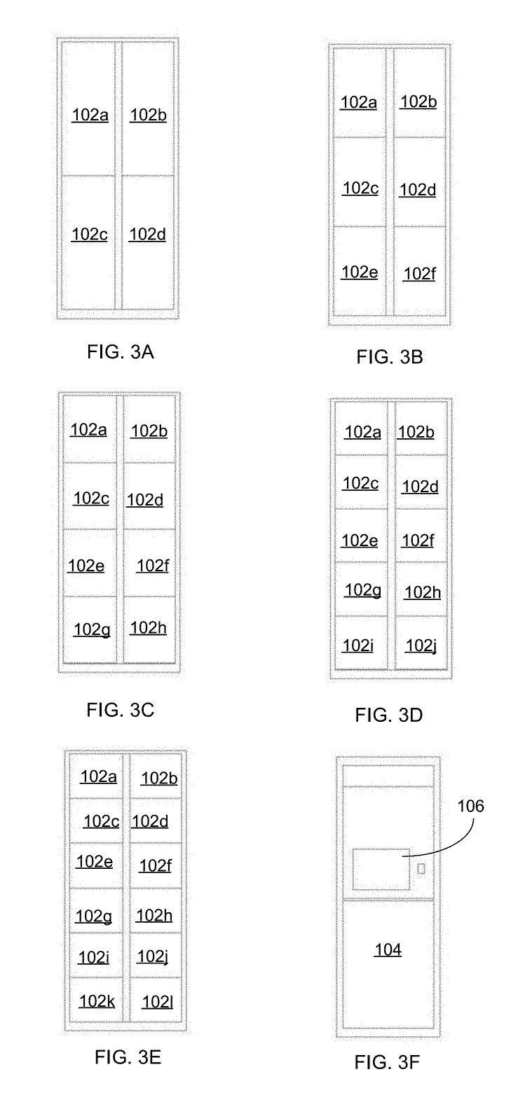

As FIGS. 3A-3F illustrate, the lockers 102a-1 have a modular configuration that enables adaptation into multiple configurations, and facilitated mobility of the networked storage system 100. The lockers 102a-1 are generally stacked and positioned adjacently, forming a set of lockers 102a-1. In some embodiments of the present invention, multiple sets of lockers 102a-1 may be used, with each set having a different arrangement.

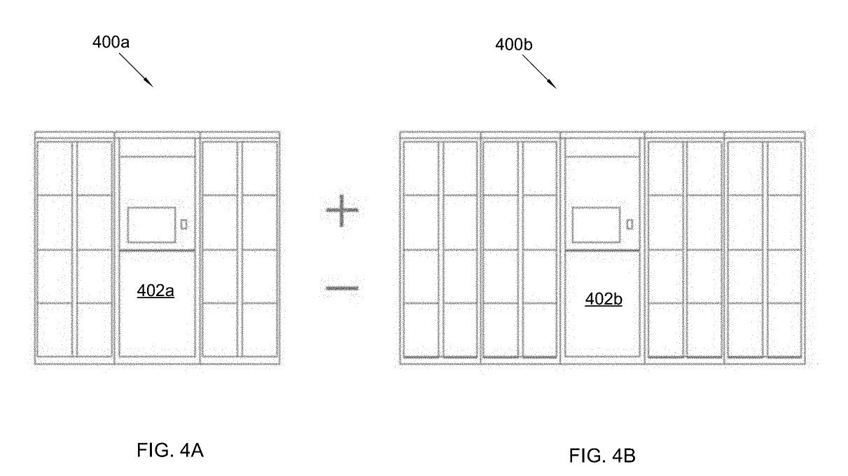

FIG. 3A illustrates 4 large lockers stacked in a rectangular arrangement. FIG. 3B illustrates 6 lockers stacked in a rectangular arrangement. FIG. 3C illustrates 8 lockers stacked in a rectangular arrangement. FIG. 3D illustrates 10 lockers stacked in a rectangular arrangement. FIG. 3E illustrates 12 lockers stacked in a rectangular arrangement. FIG. 3F illustrates a central kiosk, described below, that controls access to the lockers and also stores locker information. A user may engage the central kiosk to access a desired locker, inquire about the availability of a locker, or provide special instruction for a locker. In this manner, the lockers may be adapted for different locations and manipulated to accommodate changing storage requirements. For example, FIGS. 4A and 4B illustrate frontal views of modular lockers where the number of lockers is expanded from a set of lockers 400a having two columns of lockers and a central kiosk 402a, to a set of lockers 400b having four columns of lockers and a central kiosk 402b. Though in other embodiments, any number or arrangement of lockers may be used.

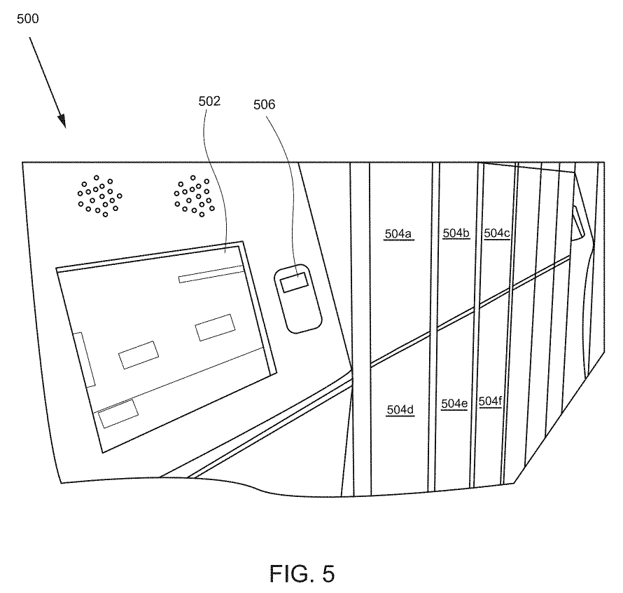

Turning now to the close up view in FIG. 5, the lockers 504a-f may be networked with a central kiosk 500. The central kiosk 500 is generally proximal to the lockers 504a-f, such that a user may easily access the central kiosk 500 to allow access to the lockers 504a-f, or perform other general functions pertinent to the lockers 504a-f. The central kiosk 500 may be configured to store locker information and pertinent information about the user. A user may engage an input device 502, such as a touch screen, on the central kiosk 500 to access a desired locker 504a, inquire about the availability of a locker 504a, or provide special instruction for a locker 504a. An identifying characteristic reader 506, described below, enables authentication of an identifying characteristic of the user. For example, a finger vein reader is shown in FIG. 5.

The locker information is used to allocate lockers to appropriate users. The locker information may also be useful for associating a user and user information with a locker, identifying malfunctioning lockers, and identifying unauthorized manipulation of items in the lockers. In some embodiments, the locker information may include, without limitation, a location of the plurality of lockers, an identification of the plurality of lockers, a locker number, a locker rental cost, a user associate with the plurality of lockers, locker access information, the at least one identifying characteristic, the barcode, the rewritable locker access code, an activation indication indicating whether one of the plurality of lockers has been accessed, a use indication indicating whether the plurality of lockers is being rented for single re-entry or multiple re-entry type use, and a duration indicating a time period over which the plurality of lockers are accessible in accordance with a locker rental plan. The central kiosk may use this locker information for enabling a user to access the lockers, for monitoring the lockers, and for processing events at the lockers.

Looking again at FIG. 5, the central kiosk may include an input device that allows the user to access the lockers, and inquire about locker information. In one embodiment, the input device is a touch screen. The touch screen is configured to enable facilitated control and access of the locker. The touch screen may be layered on the top of an electronic visual display of the central kiosk. The user can give input or control the central kiosk through simple or multi-touch gestures by touching the touch screen with a special stylus and/or one or more fingers.

The plurality of lockers 102a-1 and the central kiosk 104 may be operatively connected with a remote processor 108 through the network 112. The remote processor 108 communicates, chiefly with the central kiosk 104, which is then engaged by the user to access and input information to the lockers 102a-1.

In another embodiment, the locker information 110 that is input by the user into the central kiosk 104 is transmitted to, and stored in the remote processor 108. The remote processor 108 serves as the central processing, storing, and decision making device for the networked storage system. In essence, the remote processor 108 serves as a master, and the central kiosk 104 serves as a slave. Though in alternative embodiments, the central kiosk 104 is the primary processing and storage device.

In one embodiment, the locker information 110 in the remote processor 108 is programmable so that it may be modified to satisfy a user's particular locking and opening requirements for a locker 102a. For example, a user of the lockers in an airport or bus station may have different operating requirements than a user in a gymnasium or school environment, e.g., the airport user may want to change money while the school user may want the system to be free.

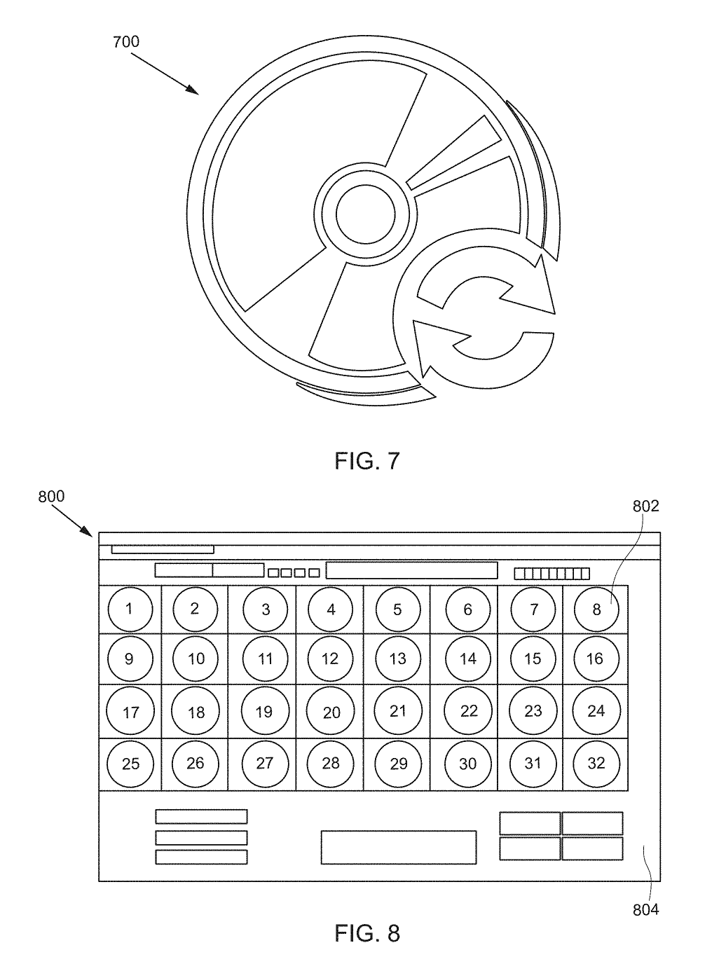

The remote processor 108 is configured to store the locker information 110 and also information about the user in a memory 700 (FIG. 7). The remote processor 108 may also monitor events that occur at the lockers. In one embodiment, the remote processor 108 is configured for backstage management of the locker information through a multiple interface 800 in an input device 802 of a central kiosk 804, as shown in FIG. 8.

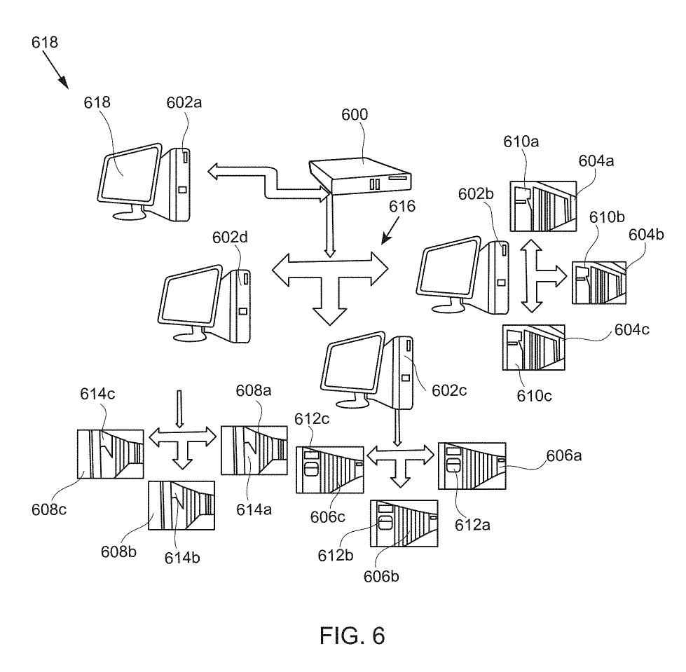

However, as shown in FIG. 6, other embodiments of a networked storage system 618 may utilize multiple sets of lockers 604a-c, 606a-c, 608a-c that are networked with multiple sets of central kiosks 610a-c, 612a-c, 614a-c. The multiple sets of central kiosks 610a-c, 612a-c, 614a-c can be engaged by the user to access and input information for the multiple sets of lockers 604a-c, 606a-c, 608a-c. The multiple sets of lockers 604a-c, 606a-c, 608a-c may be disposed remotely from each other in this arrangement. A single remote processor 600 may control the 610a-c, 612a-c, 614a-c, and may also be remotely located from the lockers 604a-c, 606a-c, 608a-c. Further, each set of central kiosks 610a-c, 612a-c, 614a-c may have a server 602a-d to communicate with the single remote processor 600.

Looking again at FIG. 6, a network 616 allows communication between the user, the central kiosks 610a-c, 612a-c, 614a-c, and the remote processor 600. The open communication allowed by the network 616 allows the central kiosks 610a-c, 612a-c, 614a-c to communicate with the remote processor 600, which is itself operatively connected to the lockers 604a-c, 606a-c, 608a-c; thereby enabling access and monitoring of the lockers 604a-c, 606a-c, 608a-c. In some embodiments, the network 616 comprises an application 618. The application may include, without limitation, a website, a social media site, a video, a digital audio, a fax, an email, and a call center.

In view of the above, it should be appreciated that some portions of the description that follows are presented in terms of algorithms and symbolic representations of operations on data within a computer memory. These algorithmic descriptions and representations are the means used by those skilled in the computer science arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated.

It has proven convenient at times, principally for reasons of common usage, to refer to these signals as bits, values, elements, symbols, characters, terms, numbers or the like. It should be borne in mind, however, that all of these and similar terms are to be associated with the appropriate physical quantities and are merely convenient labels applied to these quantities. Unless specifically stated otherwise, it will be appreciated that throughout the description of the present invention, use of terms such as “processing”, “computing”, “calculating”, “determining”, “displaying” or the like, refer to the action and processes of an appropriately programmed computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention can be implemented with an apparatus to perform the operations described herein. This apparatus may be specially constructed for the required purposes, or it may comprise a computer system that is selectively activated or reconfigured by a computer program which it executes and which is stored on one or more computer-readable storage mediums accessible to processing elements of the computer system.

For example, such a computer program may be stored in a computer readable storage medium, such as, but not limited to, any type of disk including floppy disks, optical disks, compact disk read only memories (CD-ROMs), and magnetic-optical disks, read-only memories (ROMs), flash drives, random access memories (RAMS), erasable programmable read only memories (EPROMs), electrically erasable programmable read only memories (EEPROMs), flash memories, other forms of magnetic or optical storage media, or any type of media suitable for storing electronic instructions, and each accessible to a computer processor, e.g., by way of a system bus or other communication means.

The algorithms and processes presented herein are not inherently related to any particular computer system, processor or other apparatus. Various electronic computing apparatus, along with, where necessary, suitable computer programs that instantiate processes in accordance with the teachings herein, may be used. For example, any of the present methods can be implemented in hard-wired circuitry, by appropriate programming of a computer processor or processors, or any combination of hardware and software may be used to carry out the method discussed below.

Of course, the invention can be practiced with computer system configurations other than those particularly described below, including systems that comprise hand-held devices, multiprocessor systems, microprocessor-based electronic devices, digital signal processor-based devices, networked computer systems, minicomputers, mainframe computers, personal computers, and the like, and it should be recognized that these examples presented herein are used merely for purposes of illustration. The invention can also be practiced in distributed computing environments where tasks are performed by computer processing devices that are remote to one another, either physically and/or logically, and are linked through one or more communications networks. The required structure for a variety of these systems will appear from the description below.

Looking back at FIG. 1, each locker 102a-1 has a door and a door lock. The door lock moves between an unlocked position that enables access to an interior of the locker 102a, and a locked position that releasably locks the door to enable access to the locker 102a. The locked position restricts unauthorized entry to the interior of the locker 102a. The door is releasable to the unlocked position upon actuation of at least one of the following events: detection of at least one identifying characteristic 900a, 900b of the user, scanning of a barcode 1000, and entry of a rewritable locker access code 1100. The user may utilize any or all of these events of the invention to access the locker 102a, or perform other locker related functions.

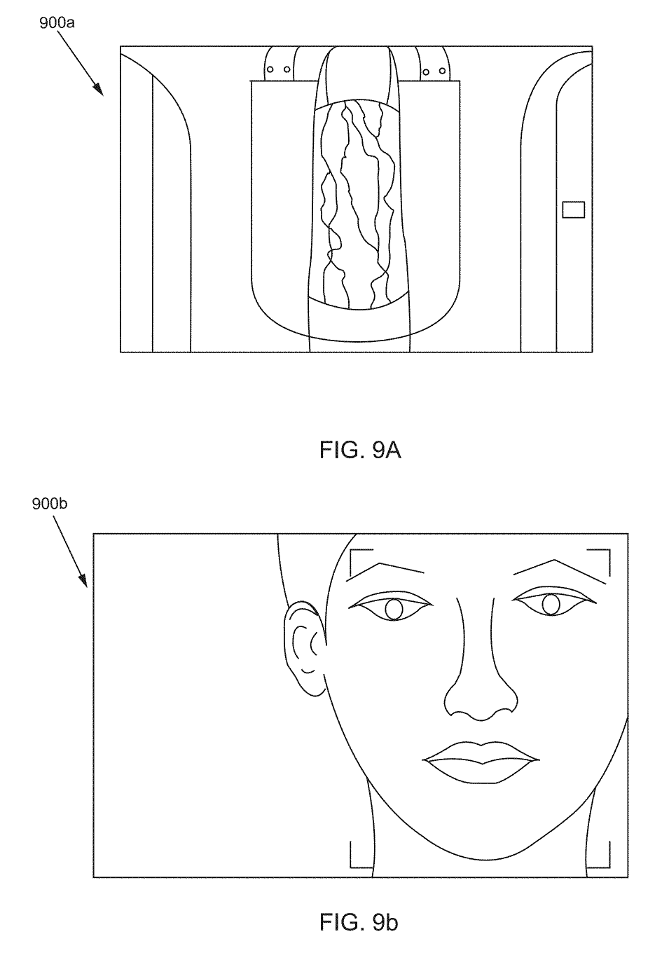

As FIGS. 9A and 9B show, the remote processor is configured to store the at least one identifying characteristic 900a, 900b from the user. An identifying characteristic reader 506 operatively connects to the central kiosk and the door lock of the lockers. The identifying characteristic reader 506 selectively unlocks the door when the identifying characteristic 900a, 900b is authenticated by the user. In this manner, the user may authenticate the identifying characteristic 900a, 900b at the central kiosk 104 to release the door lock and consequently, access the locker 102a.

The at least one identifying characteristic 900a, 900b may include a biometric, such as: fingerprint, palm veins, finger veins 900a (FIG. 9A), face recognition 900b (FIG. 9B), voice recognition, DNA, palm print, hand geometry, iris recognition, retina, and scent. In one embodiment, the identifying characteristic of voice recognition enables voice activation of the central kiosk to access and regulate the lockers. In this manner, the user may speak directly to the central kiosk to unlock the door of a locker or provide instructions for the lockers.

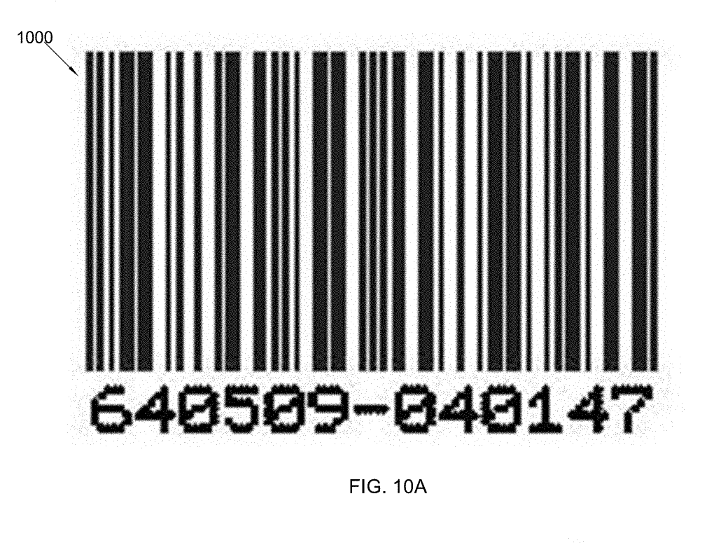

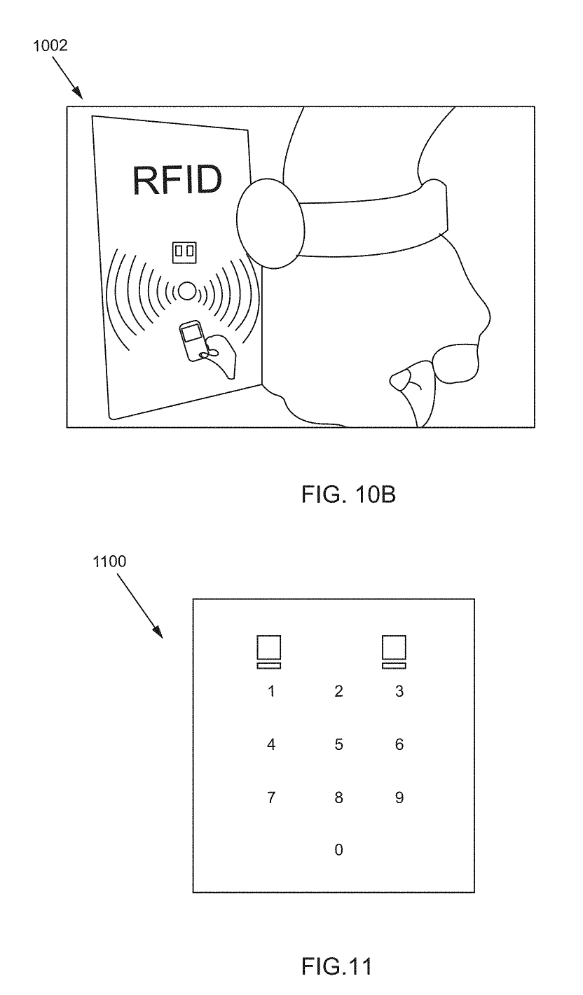

Turning now to FIG. 10A, the remote processor 108 is configured to store data from a barcode 1000. The barcode 1000 may include, without limitation, an IC card 1002 (FIG. 10B), an e-card, a magnetic barcode card, and a barcode bracelet. A barcode scanner (not shown) operatively connects to the central kiosk 104 and the door lock of the lockers 102a-1. The barcode scanner selectively unlocks the door when scanning the barcode 1000. The barcode scanner scans the barcode 1000 to release the door to the unlocked position. A user may easily position the barcode in front of the barcode scanner for this function.

Looking now at FIG. 11, the remote processor 108 is configured to store a rewritable locker access code 1100. The rewritable locker access code 1100 may be a password generated by the user. An access code reader (not shown) operatively connects to the central kiosk 104 and the door lock of the plurality of lockers 102a-1. The access code reader selectively unlocks the door when reading the rewritable locker access code 1100. The user may enter the rewritable locker access code 1100 into the central kiosk to release the door to the unlocked position. The user may also rewrite the rewritable locker access code 1100, or enter special instructions for the locker through the input device of the central kiosk 104. The rewritable locker access code 1100 may include a password that can be changed regularly.

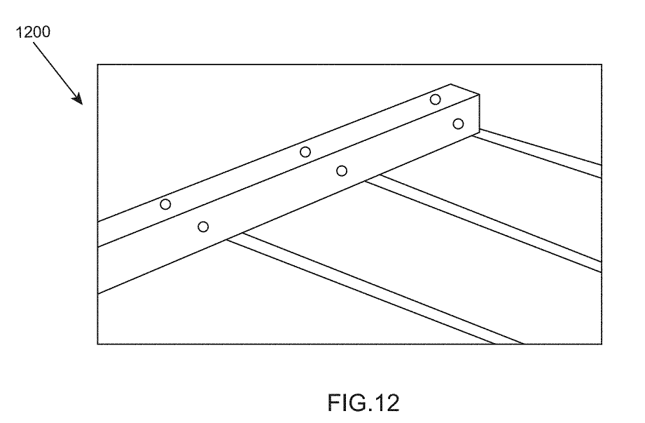

Turning now to FIG. 12, each locker includes an enclosure defining an interior for storing items. As an added security feature, a motion detection apparatus 1200 in the interior of the locker 102a monitors the items and alerts to unauthorized manipulation of the items to the remote processor and/or the central kiosk 104. The motion detection apparatus 1200 detects motion in the interior of the locker 102a, and indicates to the remote processor 108 when motion is detected in the interior of the locker 102. This may include theft.

The motion detection apparatus 1200 detects motion in the interior of the lockers 102a-1, and indicates to the remote processor 108 when motion is detected in the interior of the lockers 102a-1. The remote processor 108 may then alert by sending a signal to the central kiosk 104, sending a signal to law enforcement reception, or sending a signal to an electronic device of the user. The motion detection apparatus 1200 may include a laser, an infrared, an optical, a microwave, an acoustic sensor, and a transmitter for illumination.

In an alternative embodiment, the central kiosk 104 includes a vending apparatus that dispenses a vended object, such as a towel, a drink, a garment, and glasses, that may be pertinent to the location of the lockers. The vending apparatus may be integrated into the central kiosk 104, or located at a distance from the central kiosk 104. The user may pay for the vended product at the central kiosk 104 through cash, credit card, and virtual currency. The locker information may also include a currency balance of the user. The user may actuate the identifying characteristic 506, the barcode 1000, or the rewriteable locker access code 1100 to pay for the vended product from the currency balance.

Additionally, the central kiosk 104 comprises a payment mechanism 116, such as a bill changer, coin receiver, or change machine to process cash payments. The payment mechanism 116 may also have a credit processor or accept and process payment by debit or credit card. In yet another embodiment, the payment mechanism may be configured to transact online payments, whereby a user may pay remotely through online payment companies, such as PAYPAL or ALIPAY. The payment mechanism 116 performs transactions through transaction methods known in the art.

In another alternative embodiment, the central kiosk 104 comprises a charging dock (not shown) for charging an electronic device. However, in other embodiments, each locker 102a-1 may have an individual charging dock. The charging dock may carry a variety of signals and power, through a single connector, to simplify the process of docking the mobile device. The charging dock may be embedded in the central kiosk or a locker to support or align the electronic device or may be at the end of a cable.

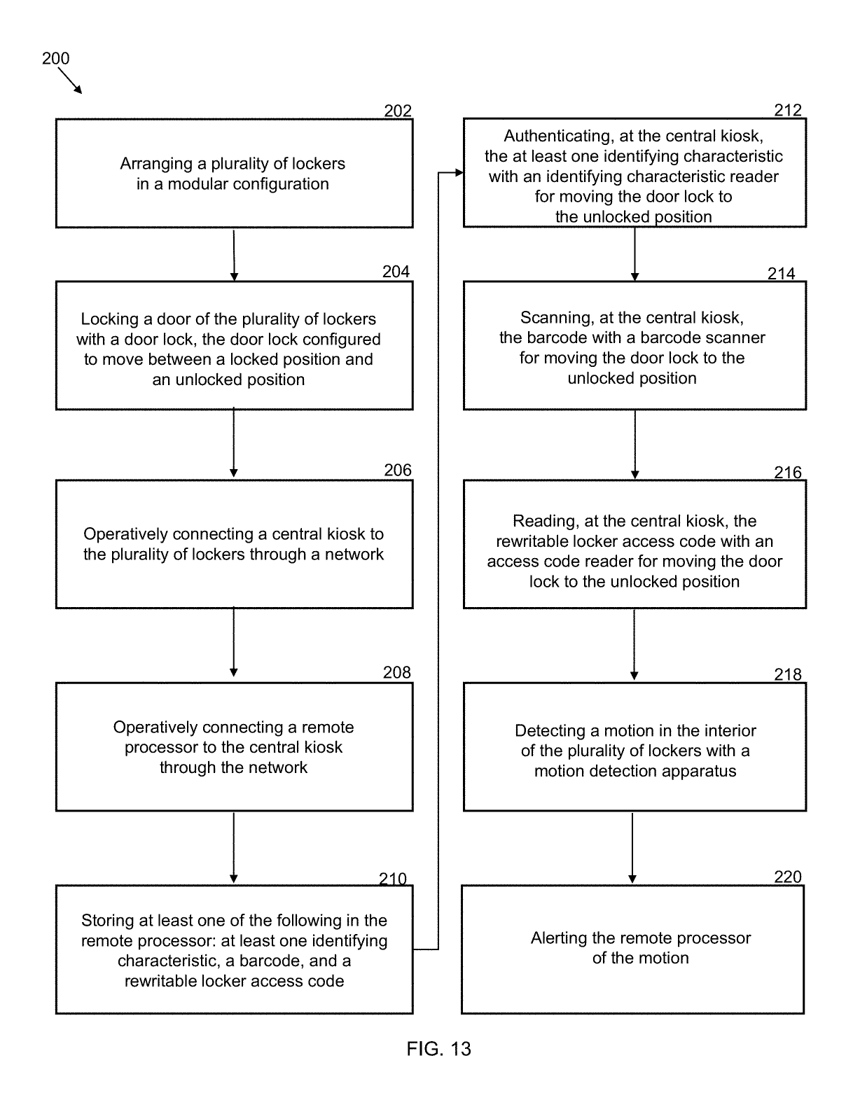

FIG. 13 illustrates a flowchart diagram of an exemplary networked storage method 200 for storing items in a plurality of lockers 102a-1, and enabling network communication between the lockers 102a-1, a central kiosk 104, and a remote processor 108. The method 200 may include an initial Step 202 of arranging a plurality of lockers 102a-1 in a modular configuration for adaptation into multiple configurations.

The method 200 may further comprise a Step 204 of locking a door of the plurality of lockers 102a-1 with a door lock, the door lock configured to move between a locked position and an unlocked position. A Step 206 includes operatively connecting a central kiosk 104 to the plurality of lockers 102a-1 through a network 112. The central kiosk 104 may include an input device 106 that allows the user to access the lockers 102a-1, and inquire about locker information 110. In one embodiment, the input device 106 is a touch screen. The touch screen is configured to enable facilitated control and access of the locker. The touch screen may be layered on the top of an electronic visual display of the central kiosk 104. The user can give input or control the central kiosk 104 through simple or multi-touch gestures by touching the touch screen with a special stylus and/or one or more fingers.

In some embodiments, a Step 208 comprises operatively connecting a remote processor 108 to the central kiosk 104 through the network 112. As referenced in FIG. 6, the lockers 102a-1 and the central kiosk 104 may also be networked with a remote processor 108. The remote processor 108 may be remotely located from the lockers 102a-1. The remote processor 108 is configured to store the locker information 110 and also information about the user in a memory (FIG. 7). A Step 210 includes storing at least one of the following in the remote processor 108: at least one identifying characteristic 506, a barcode 1000, and a rewritable locker access code 1100.

In some embodiments, a Step 212 may include authenticating, at the central kiosk 104, the at least one identifying characteristic 506 with an identifying characteristic reader 114 for moving the door lock to the unlocked position. The identifying characteristic reader 114 operatively connects to the central kiosk 104 and the door lock of the lockers 102a-1. The identifying characteristic reader 114 selectively unlocks the door when the identifying characteristic is authenticated by the user. For example, when a fingerprint is engaged to a fingerprint reader, or when a voice is recognized by voice recognition software. Though, any biometric means known in the art may be used for this function.

A Step 214 comprises scanning, at the central kiosk 104, the barcode 1000 with a barcode scanner for moving the door lock to the unlocked position. The barcode 1000 may include, without limitation, an IC card (FIG. 10B), an e-card, a magnetic barcode card, and a barcode bracelet. A barcode scanner operatively connects to the central kiosk 104 and the door lock of the plurality of lockers 102a-1. The barcode scanner selectively unlocks the door when scanning the barcode 1000. The barcode scanner scans the barcode 1000 to release the door to the unlocked position.

A Step 216 includes reading, at the central kiosk 104, the rewritable locker access code 1100 with an access code reader for moving the door lock to the unlocked position. The rewritable locker access code 1100 may be a password generated by the user. An access code reader operatively connects to the central kiosk 104 and the door lock of the plurality of lockers 102a-1. The access code reader selectively unlocks the door when reading the rewritable locker access code 1100.

In some embodiments, a Step 218 comprises detecting a motion in the interior of the plurality of lockers 102a-1 with a motion detection apparatus 1200. The motion detection apparatus 1200 in the interior of the locker monitors the items and alerts the remote processor 108 and/or the central kiosk 104 to unauthorized manipulation of the items. This may include theft. A final Step 220 comprises alerting the remote processor 108 of the motion. The motion detection apparatus detects motion in the interior of the lockers 102a-1, and indicates to the remote processor 108 when motion is detected in the interior of the lockers 102a-1. The remote processor 108 may then alert by sending a signal to the central kiosk 104, sending a signal to law enforcement reception, or sending a signal to an electronic device of the user.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A networked storage system, the system comprising:
a plurality of lockers defined by a modular arrangement configured to enable multiple arrangement, the plurality of lockers comprising an enclosure defining an interior, the plurality of lockers further comprising a door configured to enable and restrict access to the interior, the door having a door lock configured to move between a locked position and an unlocked position,
whereby the door inhibits access to the interior when the door lock is in the locked position and the door allows access to the interior when the door lock is in the open position;
a central kiosk configured to operatively connect to the plurality of lockers, the central kiosk further configured to control the door lock of the plurality of lockers through an input device, the central kiosk further configured to store a locker information;
a remote processor configured to operatively connect to the plurality of lockers and the central kiosk, the remote processor having a memory configured to store the locker information;
a network configured to enable communication between the central kiosk and the remote processor;
an identifying characteristic reader configured to operatively connect to the central kiosk and the door lock of the plurality of lockers, the identifying characteristic reader further configured to selectively unlock the door when authenticating at least one identifying characteristic;
a barcode scanner configured to operatively connect to the central kiosk and the door lock of the plurality of lockers, the barcode scanner further configured to selectively unlock the door when scanning a barcode;
an access code reader configured to operatively connect to the central kiosk and the door lock of the plurality of lockers, the access code reader further configured to selectively unlock the door when reading a rewritable locker access code; and
motion detection apparatus disposed in the interior of the plurality of lockers, the motion detection apparatus configured to detect motion in the interior of the plurality of lockers, the motion detection apparatus further configured to indicate to the remote processor when motion is detected in the interior of the plurality of lockers,
whereby the remote processor emits an alert upon receiving indication of motion in the interior of the plurality of lockers.

2. The system of claim 1, wherein the plurality of lockers are configured in a stacked arrangement.

3. The system of claim 1, wherein the input device is a touch screen.

4. The system of claim 1, wherein the remote processor includes at least one member selected from the group consisting of: a computer, a database, a server, a cloud, and a data storage device.

5. The system of claim 1, wherein the locker information includes at least one member selected from the group consisting of: a location of the plurality of lockers, an identification of the plurality of lockers, a locker number, a locker rental cost, a user associate with the plurality of lockers, locker access information, the at least one identifying characteristic, the barcode, the rewritable locker access code, an activation indication indicating whether one of the plurality of lockers has been accessed, a use indication indicating whether the plurality of lockers is being rented for single re-entry or multiple re-entry type use, and a duration indicating a time period over which the plurality of lockers are accessible in accordance with a locker rental plan.

6. The system of claim 1, wherein the remote processor is configured for backstage management of the locker information.

7. The system of claim 1, wherein the network comprises an application.

8. The system of claim 7, wherein the application includes at least one member selected from the group consisting of: a website, a social media site, a video, a digital audio, a fax, an email, and a call center.

9. The system of claim 1, wherein the at least one identifying characteristic comprises a biometric.

10. The system of claim 9, wherein the biometric includes at least one member selected from the group consisting of: fingerprint, palm veins, finger veins, face recognition, voice recognition, DNA, palm print, hand geometry, iris recognition, retina, and scent.

11. The system of claim 10, wherein the voice recognition is configured to enable voice activation of the central kiosk.

12. The system of claim 1, wherein the barcode includes at least one member selected from the group consisting of: an IC card, an e-card, a magnetic barcode card, and a barcode bracelet.

13. The system of claim 1, wherein the rewritable locker access code comprises a password.

14. The system of claim 1, wherein the motion detection apparatus includes at least one member selected from the group consisting of: a laser, an infrared, an optical, a microwave, an acoustic sensor, and a transmitter for illumination.

15. The system of claim 1, wherein the central kiosk is configured to operatively connect to a vending apparatus.

16. The system of claim 15, wherein the vending apparatus is configured to dispense at least one of the following: a towel, a drink, a garment, and glasses.

17. The system of claim 1, wherein the central kiosk is configured to operatively connect to a charging dock.

18. The system of claim 17, wherein the charging dock is configured to charge an electronic device.

19. A networked storage system, the system comprising:
a plurality of lockers defined by a modular arrangement configured to enable multiple arrangement, the plurality of lockers comprising an enclosure defining an interior, the plurality of lockers further comprising a door configured to enable and restrict access to the interior, the door having a door lock configured to move between a locked position and an unlocked position,
whereby the door inhibits access to the interior when the door lock is in the locked position and the door allows access to the interior when the door lock is in the open position;
a central kiosk configured to operatively connect to the plurality of lockers, the central kiosk further configured to control the door lock of the plurality of lockers through a touch screen, the central kiosk further configured to store a locker information;
a remote processor configured to operatively connect to the plurality of lockers and the central kiosk, the remote processor having a memory configured to store the locker information;
a network configured to enable communication between the central kiosk, the remote processor, and the plurality of lockers;
an identifying characteristic reader configured to operatively connect to the central kiosk and the door lock of the plurality of lockers, the identifying characteristic reader further configured to selectively unlock the door when authenticating at least one identifying characteristic;
a barcode scanner configured to operatively connect to the central kiosk and the door lock of the plurality of lockers, the barcode scanner further configured to selectively unlock the door when scanning a barcode;
an access code reader configured to operatively connect to the central kiosk and the door lock of the plurality of lockers, the access code reader further configured to selectively unlock the door when reading a rewritable locker access code;
motion detection apparatus disposed in the interior of the plurality of lockers, the motion detection apparatus configured to detect motion in the interior of the plurality of lockers, the motion detection apparatus further configured to indicate to the remote processor when motion is detected in the interior of the plurality of lockers,
whereby the remote processor emits an alert upon receiving indication of motion in the interior of the plurality of lockers;
a vending apparatus configured to dispense an object;
a charging dock configured to charge an electronic device;
a payment mechanism configured to transact cash, credit, and online payments.

20. A networked storage method, the method comprising:
arranging a plurality of lockers in a modular configuration;
locking a door of the plurality of lockers with a door lock, the door lock configured to move between a locked position and an unlocked position;
operatively connecting a central kiosk to the plurality of lockers through a network;
operatively connecting a remote processor to the central kiosk through the network;
storing at least one of the following in the remote processor: at least one identifying characteristic, a barcode, and a rewritable locker access code;
authenticating, at the central kiosk, the at least one identifying characteristic with an identifying characteristic reader for moving the door lock to the unlocked position;
scanning, at the central kiosk, the barcode with a barcode scanner for moving the door lock to the unlocked position;
reading, at the central kiosk, the rewritable locker access code with an access code reader for moving the door lock to the unlocked position;
detecting a motion in the interior of the plurality of lockers with a motion detection apparatus; and
alerting the remote processor of the motion.
